(19) United States
(12) Patent Application Publication
(10) Pub. No.: US 2021/0097469 A1
(43) Pub. Date: Apr. 1, 2021

(54) SYSTEM AND METHOD FOR PREDICTING PERFORMANCE METRICS

(71) Applicant: JPMorgan Chase Bank, N.A., New York, NY (US)

(72) Inventor: Suresh Babu R. KONTI, Lewis Center, OH (US)

(21) Appl. No.: 17/060,249

(22) Filed: Oct. 1, 2020

Related U.S. Application Data
(60) Provisional application No. 62/908,689, filed on Oct. 1, 2019.

(51) Int. Cl. G06Q 10/06; G06N 20/00; G06F 16/245

(52) U.S. Cl. CPC G06Q 10/06393; G06F 16/245; G06N 20/00

(57) ABSTRACT

An embodiment of the present invention is directed to predicting performance metrics. An embodiment of the present invention may identify trends and potentially impacting days and times of the week. With an embodiment of the present invention, vendors may be engaged ahead of time and appropriate communications may be made between teams. Proactive measures may be implemented to reduce business and financial impact.

### CROSS REFERENCE TO RELATED APPLICATIONS

The application claims priority to U.S. Provisional Application 62/908,689 (Attorney Docket No. 72167.001779), filed Oct. 1, 2019, the contents of which are incorporated herein in their entirety.

### FIELD OF THE INVENTION

The invention relates generally to a system and method for predicting performance metrics using artificial intelligence.

### BACKGROUND OF THE INVENTION

Key performance indicators for operating system (OS) instances include CPU, memory, network, and storage area network (SAN) input-output (IO) response times. Existing tools and utilities provide a view of current and past usage statistics. These tools are often used to help with post-diagnostics of a problem. There is an increase in the number of customer impacting incidents over recent years. This may be attributed to aggressive growth, complexity, customer demands and competition.

Impacting incidents have a financial impact to the company and customer dissatisfaction. Critical applications including digital applications have a higher financial impact and could cost potentially millions of dollars.

These and other drawbacks exist.

### SUMMARY OF THE INVENTION

According to an embodiment, the invention relates to a system that implements performance metrics predictions. The system comprises: a memory that stores historical performance data; an interface that retrieves historical performance data from one or more data sources; and a computer processor coupled to the memory and the interface and programmed to perform the steps of: obtaining, via the interface, one or more data requirements; receiving data from one or more data sources based on the one or more data requirements, the data relating to a plurality of target predictors relating to CPU, input-output, memory, network and application logs; segregating the data into multiple components comprising a residual component and a rhythm component, the residual component representing variance data and the rhythm component representing static data; based on the residual component, creating a model to generate prediction data; combining the rhythm component with the prediction data; identifying one or more peak points responsive to time-series analysis of the combined rhythm component and prediction data; categorizing the one or more peak points into known peaks and unknown peaks; and generating a mitigation response for the unknown peaks.

According to another embodiment, the invention relates to a method that implements performance metrics predictions. The method comprises the steps of: obtaining, via an interface, one or more data requirements; receiving data from one or more data sources based on the one or more data requirements, the data relating to a plurality of target predictors relating to CPU, input-output, memory, network and application logs; segregating the data into multiple components comprising a residual component and a rhythm component, the residual component representing variance data and the rhythm component representing static data; based on the residual component, creating a model to generate prediction data; combining the rhythm component with the prediction data; identifying one or more peak points responsive to time-series analysis of the combined rhythm component and prediction data; categorizing the one or more peak points into known peaks and unknown peaks; and generating a mitigation response for the unknown peaks.

The invention may include a specially programmed computer system comprising one or more computer processors, interactive interfaces, electronic storage devices, and networks. The computer implemented system and method described herein provide unique advantages to entities, organizations, customers and other users, according to various embodiments of the invention. While some of the impacting incidents cannot be avoided, it is possible to “see” some potential impacting incidents. The impact to customers may include downtime for applications, causing a chain-reaction to failover the database to alternate sites and performing Root Cause Analysis (RCA) with many teams involved. There is a considerable financial impact to all of this. Impacting incidents may be classified into buckets, e.g., high-volume days, patching schedules, CPU-spikes, database (DB) timeouts, high input output (IO) response times, etc. An embodiment of the present invention is directed to predicting a potential Business Impact in the near future, e.g., next 2 weeks. With this knowledge, a Business may respond with appropriate preventive measures and thereby lessen or even avoid the impact. An embodiment of the present invention mitigates and/or avoids potential impacting incidents and further realizes significant savings in resources.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIGS. 1A and 1B illustrate examples of data analytics, according to an embodiment of the present invention.

FIG. 2 is an exemplary flow diagram for predicting performance metrics, according to an embodiment of the present invention.

FIG. 3 illustrates an example of point peaks, according to an embodiment of the present invention.

FIG. 4 illustrates an example of rhythm and residual components, according to an embodiment of the present invention.

FIG. 5 is an exemplary system diagram for predicting performance metrics, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to forecasting business impact and specific issues by analyzing past data using time series prediction. For example, an embodiment of the present invention may analyze data for the past 6-12 months to predict forecast models for the next two weeks. This may involve a rolling forecasting model. An embodiment of the present invention is directed to predicting key performance indicators based on time series algorithms relating to CPU, input output (IO), network, memory, log-file-scraping, etc. For example, an embodiment of the present invention may predict a profile of usage relating to business volume for a time period in the future, e.g., next two weeks. In this example, the prediction data for the next two weeks may indicate that on a particular day (or time period), a business impact is predicted to occur based on a particular reason. Business impact may refer to timeouts, slowdowns and other customer or user impacting incidents. With this information, an embodiment of the present invention may provide a response to address and/or mitigate potential business impact before they occur.

An embodiment of the present invention is directed to identifying trends and time frames that represent potentially impacting days and times of the week. With an embodiment of the present invention, vendors may be engaged ahead of time and appropriate communications may be made between teams. Proactive measures may be implemented to reduce business and financial impact. In addition, time and resources for the business may be conserved. With an embodiment of the present invention, scope for automation and self-healing may be identified.

An embodiment of the present invention may be realized using artificial intelligence, machine learning, deep learning, etc. The innovative system may use data (e.g., prepare data, analyze data, etc.) to build models (e.g., create models, train models, etc.) that forecast data (e.g., deploy model, apply model, etc.).

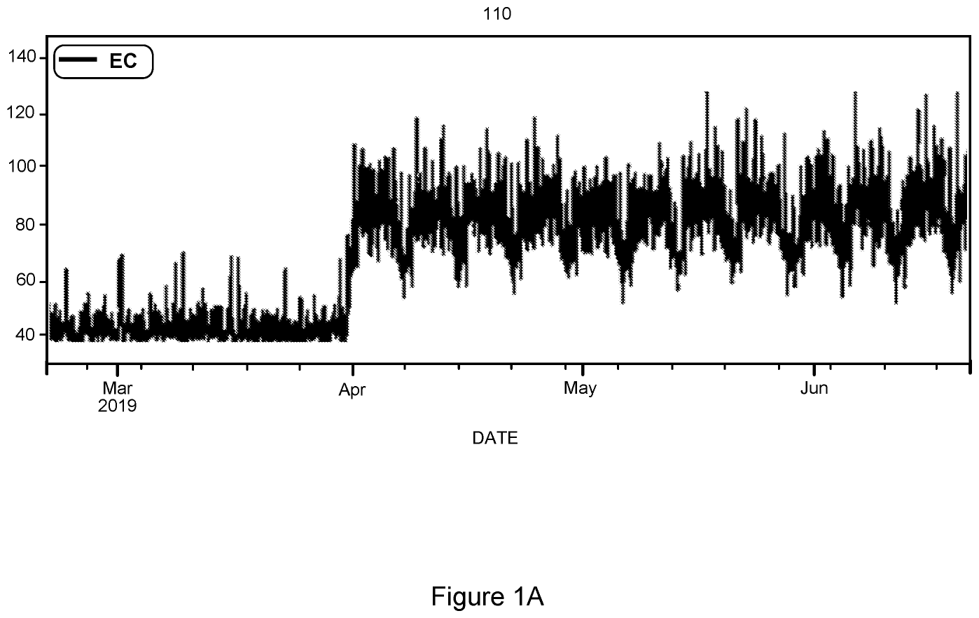

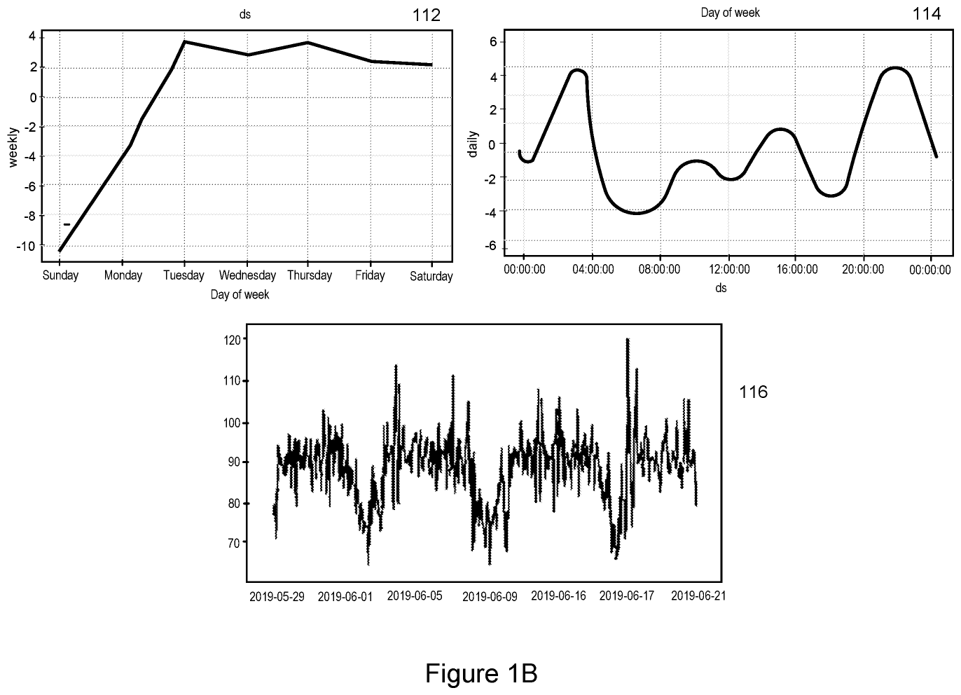

FIGS. 1A and 1B illustrate examples of data analytics, according to an embodiment of the present invention. Chart 110 illustrates performance data overview. As shown in Chart 110, EC represents entitled capacity which refers to allocated CPU. Chart 112 identifies weekly trends. As shown in Chart 112, a ramping up of business activity during the beginning of the week and a stabilizing for the rest of the week may be observed. Chart 114 identifies daily trends. Chart 114 illustrates daily trends within certain lower and upper boundaries during the week. Chart 116 identifies peaks usage. With Chart 116, peak application (CPU) usage may be identified at any given moment.

According to an embodiment of the present invention, the innovative system may predict future performance data for target predictors, e.g., CPU, IO, memory, network and log-scraping for error-conditions. Central processing unit (CPU) metrics may refer to processor/system usage, such as CPU time used by the kernel, CPU time used by user space processes, idle state/time, time spent servicing interrupts, wait time, capacity, and other metrics. Input Output (IO) metrics may refer to Operating System metrics. Memory metrics may refer to storage space, usage, utilization, access time, etc. Network metrics may refer to service quality of networks, amount of data, rate of data flow, number of packets, bandwidth, etc. Log-scraping may refer to collecting data from daily logs or other logs generated by applications or other services. For example, a log (e.g., trace logs) may be specific to errors, condition changes, etc. An embodiment of the present invention may collect historical data relating to condition changes with corresponding dates/times.

An embodiment of the present invention is directed to predicting unknown incidents as well as addressing and/or reducing Business Financial Impacts associated with such incidents. Based on experience and research, an embodiment of the present invention may recognize that the unknowns are usually caused by spikes in performance-data. These spikes may be a result of database (DB) timeouts, high IO response times, virtual machine out of memory, too-many processes, patching schedules, high-volume days/time periods, etc.

An embodiment of the present invention is directed to creating a foreseeing packaged solution that may be used across an Enterprise. An embodiment of the present invention may include a building block solution and API interface with the ability to be consumed as an API.

API Interface key features may include: create on-boarding requirements; create API portal data-upload, model-deployment to get predictions; train the model and on-board a website active OS instance. API portal may obtain and predict performance data, which may include model data (e.g., delete data, get predictions, get status, upload data), CPU data (e.g., delete data, get predictions, get status, update data, upload data), IO response times (e.g., delete data, get predictions, get status, update data, upload data), etc.

Automate Model Training key features may include: automate model training; on-board OS instances for websites; identify mission critical digital applications (e.g., website, customer interface, etc.) and prepare for onboarding.

Self-Healing key features may include: on-board mission-critical digital applications and promote activity and help other lines of business (LOB) teams to adopt various aspects of an embodiment of the present invention.

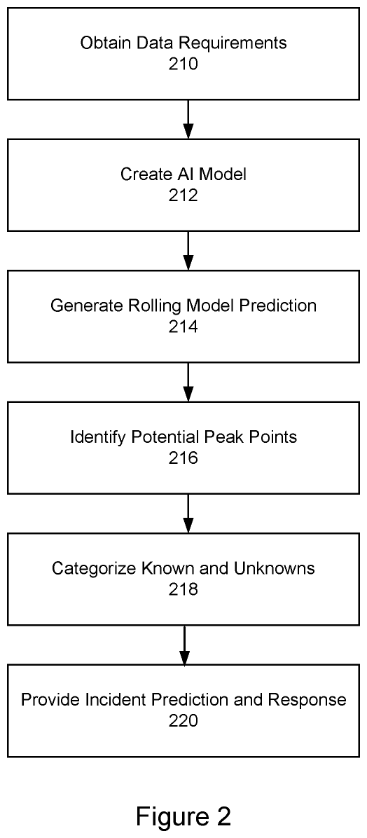

FIG. 2 is an exemplary flow diagram for predicting performance metrics, according to an embodiment of the present invention. At step 210, data requirements may be obtained. At step 212, AI model may be created using a time-series algorithm. At step 214, rolling model predictions may be generated. At step 216, potential peak points may be identified. At step 218, known and unknowns may be categorized. At step 220, prediction data and a corresponding response may be identified and provided. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Each step will be described in more detail below.

At step 210, data requirements may be obtained. Data requirements may identify the type of data to be received, performance metric that is determined, frequency and duration of data collected, source of data, data preparation specifics, etc. Data may be obtained from multiple data sources. For example, the data may represent time-stamped data. Exemplary data sources may include: CPU; Network; IO; Memory and Application Logs (e.g., virtual machine logs, Database logs, etc.). According to an exemplary illustration, recommended data may be for a time period, e.g., for past 1 year. This may help visualize yearly, quarterly, seasonal trends, etc.

Step 210 may further involve data collection and data preparation. With data collection, data may be collected on the OS instance in a local directory by a daily cronjob. The data may be written to a compressed archive, e.g., one archive per day (or other time period). With data preparation, data may be obtained for CPU and IO, for example. This data may be available from “vmstat” and “iostat” data portion of the compressed archives. “vmstat” may represent Virtual Memory statistics and “iostat” may represent Input-Output statistics. Other statistics may be captured. A script may be created to extract data from these compressed archives and tabulated to csv format (or other format). The files obtained may include “vmstat.csv” and “iostat.csv.” This may include timestamp and metrics data for CPU and IO-response time, for example.

The data may be collected over a period of time, e.g., 4 months, 6 months, 1 year, etc. In this example, data for CPU from “vmstat” may be granular and collected every second. An embodiment of the present invention may recognize that this is too much data that adds noise to the AI model. Accordingly, the number of data samples may be reduced to hourly (or other time period). An hourly sample of the data containing a MAX metric may be chosen for the analysis. A similar approach may be applied to “iostat” data to determine IO-response time. Data may be resampled hourly to get MAX response-time for a given hour. Other time periods and frequency may be applied so that the data is manageable.

At step 212, AI model may be created using a time-series algorithm. The data may be appropriately normalized, processed and made ready for AI models. The recommended Time-Series AI models for this Dataset may include: Long-Short Term Memory (LSTM) network, Seq2Seq and Cony 1D Neural Network. Other models may include Recurrent Neural Networks, Holt Winters Algorithm, Prophet Library, ARIMA, etc. Various other models and algorithms may be implemented. FIG. 1A illustrates exemplary training data at 110.

An embodiment of the present invention may train a model with training data for a time period, such as 14 weeks. An embodiment of the present invention may then predict the result and tally with the actual values for the last 2 weeks. Other variations may be applied.

At step 214, rolling model predictions may be generated. The predictions may be derived using AI Models for a next forecasted duration. FIG. 1B illustrates exemplary prediction data at 116.

An embodiment of the present invention may be applied to CPU analysis and predictions. As shown in FIG. 1A, chart 110 may represent training data. As shown in FIG. 1B, chart 112 represents weekly trend analysis and chart 114 represents daily trend analysis. Chart 116 may represent model prediction. An embodiment of the present invention may apply to application response time analysis and predictions as well as various time series data including network components, memory usage, log-file scraping techniques. Trends may be identified for various time periods, e.g., a week, two weeks, 24 hour period, etc. In addition, peak and valley activity may be easily identified for future time periods.

The various features of the invention may be applied to business critical and other applications, services, etc.

At step 216, peak points may be identified. An embodiment of the present invention may provide predictions in a graph format. Other interfaces and formats may be realized. The graph format may illustrate peaks and other variations in the prediction for an estimated time period (e.g., next two weeks).

At step 218, known and unknowns may be categorized. An embodiment of the present invention recognizes that not every peak point is a problem. For example, an exemplary graph prediction may include peaks for 4 out of 14 days. In this example, there may be a peak on days 1, 3, 5 and 7. An embodiment of the present invention may recognize that some of the peaks are expected and within the realm of normal performance. For example, day 3 may be a Friday, which is a historical high volume day because it is the end of the work week and peak usage is expected at that time. Day 5 may represent a quarter end processing day. Because it marks the end of a quarter, day 5 is expected to be a peak volume day. Accordingly, by eliminating expected behavior or peak days, an embodiment of the present invention may focus on day 1 and day 7 as business impact events. An embodiment of the present invention may account for other factors, considerations, events, etc.

Using an AI Performance Time-Series Modelling, an embodiment of the present invention may predict a performance profile for future dates. An entity may then take appropriate preventive measures to lessen or eliminate the potential impact.

At step 220, prediction data and a corresponding response may be identified and provided. Based on the prediction metrics, an embodiment of the present invention may provide an identification of a business impact event with a corresponding projected date and/or time period. For example, a spike in activity may be predicted on a particular day within a specific time range. In addition, a corresponding mitigating response may be provided. The response may be automatically implemented or otherwise initiated by an embodiment of the present invention. The predicted business impact event and mitigation response may be communicated via an interface or other electronic communication to one or more designated recipients or receiving systems or applications.

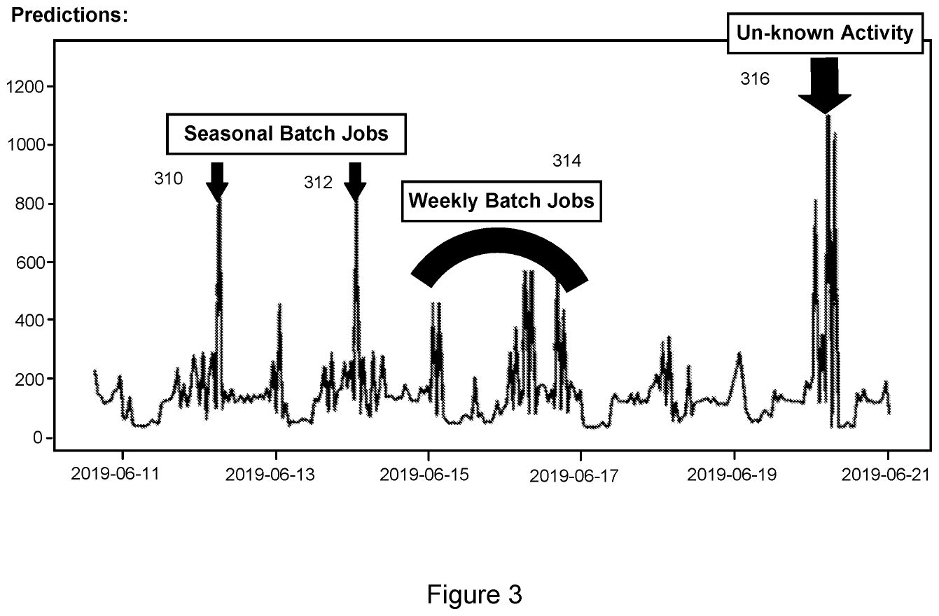

FIG. 3 illustrates an example of point peaks, according to an embodiment of the present invention. As shown in FIG. 3, peak data may be representative of expected behavior or events. In this example, peak points 310, 312 represent seasonal batch jobs. Peak points represented by 314 indicate weekly batch jobs. An embodiment of the present invention may further identify peak activity as unknown activity, as shown by peak point 316. In this example, peak point 316 represents a business impacting event. Peak point 316 may be further analyzed to identify a source or root cause. In addition, a corresponding mitigation response and/or action may be identified and/or applied.

Current approaches result in inconsistent prediction data where models do not give accurate results. In addition, current approaches require an extended time to run through the data (epochs) and the same modeling technique does not work for all target predictors. Time Series AI data modelling techniques may include LSTM (Long Short Term Memory), Seq2Seq, Conv1D, etc. Models may behave differently for the same set of input data thereby producing inconsistent results.

An embodiment of the present invention is directed to working with residual data to obtain consistent predictions using AI algorithms. This approach involves segregating the data into multiple components and working with one component. An embodiment of the present invention may use a statsmodel technique to segregate data and work on only the residual data component. Statsmodel is one exemplary technique that allows users to estimate statistical models and perform statistical analysis and tests. Other techniques and/or modules may be applied. An embodiment of the present invention may be directed to using a statsmodel technique to segregate data to Rhythm, Trend and Residual; and using only the residual data and creating a model using LSTM, or Seq2Seq or Conv 1D techniques.

For example, an embodiment of the present invention may split a graphical pattern into multiple sections including a rhythm section and a residual section. The rhythm section may represent stationary or constant data. The residual section may represent the data with variance. An embodiment of the present invention may use only the residual data as input for the prediction. For example, the residual data is used in the prediction model. Once the prediction data is obtained, an embodiment of the present invention may then add the rhythm component to get the forecasted signals.

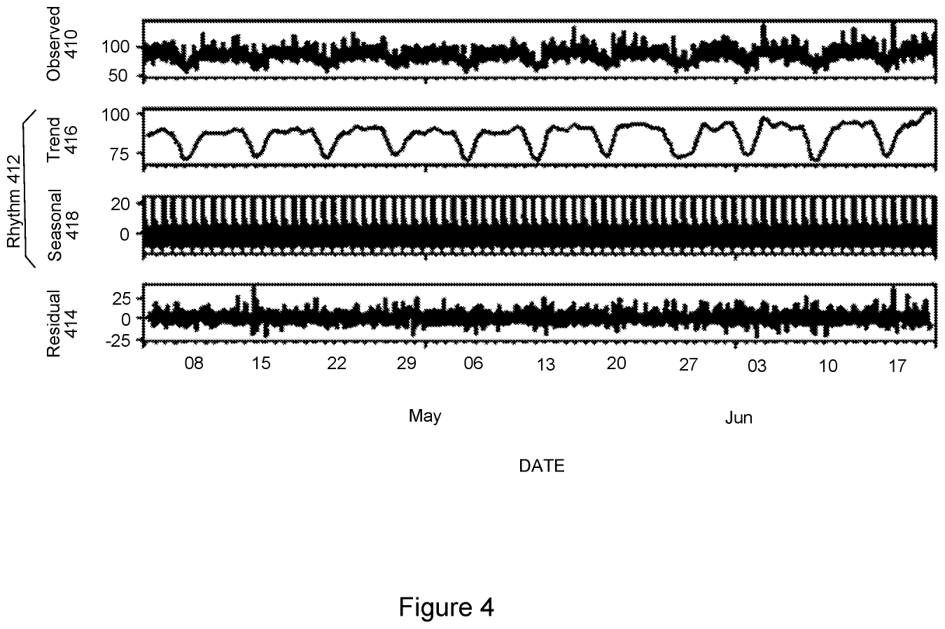

FIG. 4 illustrates an example of rhythm and residual components, according to an embodiment of the present invention. By decomposing the data into different components and working with one of the data-components that has greater variance, the results depict improved accuracy and consistency between different AI modelling techniques.

As shown in FIG. 4, using a statsmodel technique, the observed data (actual data) 410 is decomposed to Rhythm (412) and Residual (414) components. The Rhythm (412) components may include Seasonal (418) and/or Trend (416) sub-components. By using only residual data components (414) for AI model analysis, an embodiment of the present invention may achieve faster and improved results. The Rhythm components of data may then be added to achieve the new observed data. This new observed data may be used in time-series analysis, e.g., LSTM or Seq2Seq or Conv 1D techniques. An embodiment of the present invention may add rhythm-data component to the results of the residual-data analysis.

Another embodiment of the present invention is directed to working with noise data. This approach may involve data manipulation techniques. An embodiment of the present invention may take the mean of the dataset and then reduce the dataset signals with mean (e.g., datapoint-mean). This will give only the noise/residual data so that this residual data may be used for the model. This may involve: calculating the mean of the dataset; reducing the datapoints by subtracting mean from each of the datapoints; using ML/AI modelling techniques (e.g., LSTM, or Seq2Seq or Conv1D) to predict future time period; and adding mean value to the predicted data to get signal values.

Accordingly, the various embodiments of the present invention may achieve advantages and benefits including: reduction in the number of datapoints for modelling; taking less time to get results; improved accuracy for predictions; and models working consistently better. An embodiment of the present invention is directed to creating a building block approach for each of the predictors and further using an API interface for data consumption and delivery of predictions.

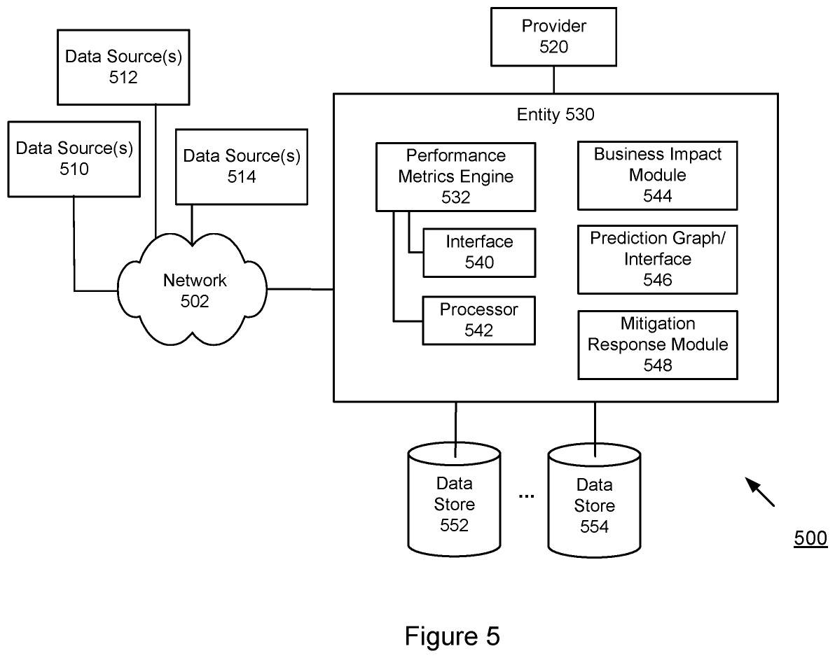

FIG. 5 is an exemplary system diagram for predicting performance metrics, according to an embodiment of the present invention. As illustrated in FIG. 5, Network 502 may be communicatively coupled to various data sources, represented by Data Source(s) 510, 512, 514 via various computing devices. Data sources may include local and/or remote resources. Other inputs may be received. Data sources may include various devices, systems and/or components including servers, computers, laptops, workstations, kiosks, terminals, tablets, mobile devices, mobile phones, smart devices, network/communication devices, memory components, routers, switches, etc. Network 502 communicates with Entity 530 that implements performance metrics predictions. Entity 530 may implement Performance Metrics Engine 532 that generates performance metrics to accurately identify business impacts and generate a response to address and/or mitigate the business impacts.

Performance Metrics Engine 532 may also incorporate modules and other functions, such as Interface 540, Processor 542, Business Impact Module 544, Prediction Graph/Interface 546 and Mitigation Response Module 548. These modules are exemplary and illustrative, Performance Metrics Engine 532 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

Interface 540 may receive data from Data Sources 510, 512, 514. For example, data sources may represent customer facing applications. This may include an application, website, portal, etc.

Processor 542 may analyze the data from the data sources and apply a prediction algorithm/model to generate performance metrics. Processor 542 may also access metrics data from one or more databases or other memory components.

Business Impact Module 544 may predict and identify one or more business impact events based on the performance metrics. Business impact events may include a slow response time or when a customer is unable to access a website, portal and/or interface.

Prediction Graph/Interface 546 may provide a graphical analysis of the performance metrics and business impact events. The graphical analysis may illustrate peak points that indicate potential business impact events. Other graphics and interfaces may be implemented.

Mitigation Response Module 548 may identify a response and/or action to address the predicted business impact event. The response may include alerting or informing one or more recipients to prepare and address the business impact event. Actions may include adding resources to mitigate the business impact event, performing health checks, etc. Other responses and/or actions may be identified and applied.

Entity 530 may be communicatively coupled to data storage devices represented by Data stores 552, 554. Also, Data stores 552, 554 may also store and maintain metrics and prediction data, etc. The performance metrics predictions and analytics described herein may be provided by Entity 530 and/or a third party provider, represented by 560, where Provider 520 may operate with Entity 530.

The system 500 of FIG. 5 may be implemented in a variety of ways. Architecture within system 500 may be implemented as hardware components (e.g., module) within one or more network elements. It should also be appreciated that architecture within system 500 may be implemented in computer executable software (e.g., on a tangible, non-transitory computer-readable medium) located within one or more network elements. Module functionality of architecture within system 500 may be located on a single device or distributed across a plurality of devices including one or more centralized servers and one or more mobile units or end user devices. The architecture depicted in system 500 is meant to be exemplary and non-limiting. For example, while connections and relationships between the elements of system 500 is depicted, it should be appreciated that other connections and relationships are possible. The system 500 described below may be used to implement the various methods herein, by way of example. Various elements of the system 500 may be referenced in explaining the exemplary methods described herein.

Network 502 may be a wireless network, a wired network or any combination of wireless network and wired network. For example, Network 502 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 502 may support an Internet network, a wireless communication network, a cellular network, Bluetooth, or the like, or any combination thereof. Network 502 may further include one, or any number of the exemplary types of networks mentioned above operating as a stand-alone network or in cooperation with each other. Network 502 may utilize one or more protocols of one or more network elements to which it is communicatively coupled. Network 502 may translate to or from other protocols to one or more protocols of network devices. Although Network 502 is depicted as one network for simplicity, it should be appreciated that according to one or more embodiments, Network 502 may comprise a plurality of interconnected networks, such as, for example, a service provider network, the Internet, a cellular network, corporate networks, or even home networks, or any of the types of networks mentioned above.

Data may be transmitted and received via Network 502 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 5 illustrates individual devices or components, it should be appreciated that there may be several of such devices to carry out the various exemplary embodiments. Entity 530 may communicate using any mobile or computing device, such as a laptop computer, a personal digital assistant, a smartphone or other computing devices capable of sending or receiving network signals. Computing devices may have an application installed that is associated with Entity 530.

Entity 530 may be communicatively coupled to Data Stores 552, 554 as well as remote storages. These storage components may include any suitable data structure to maintain the information and allow access and retrieval of the information. For example, the storage components may keep the data in an organized fashion and may be an Oracle database, a Microsoft SQL Server database, a DB2 database, a MySQL database, a Sybase database, an object oriented database, a hierarchical database, a flat database, and/or another type of database including big data environments such as Hadoop and associated file systems and databases, as may be known in the art to store and organize data as described herein.

The storage may be local, remote, or a combination. The storage components may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The storage components may have back-up capability built-in. Communications with the storage components may be over a network, such as Network 502, or communications may involve a direct connection between the various storage components and Entity 530, as depicted in FIG. 5. The storage components may also represent cloud or other network based storage.

Other embodiments, uses, and advantages of the invention will be apparent to those skilled in the art from consideration of the specification and practice of the invention disclosed herein. The specification and examples should be considered exemplary only, and the scope of the invention is accordingly not intended to be limited thereby.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements performance metrics predictions, the system comprising:
a memory that stores historical performance data;
an interface that retrieves historical performance data from one or more data sources; and
a computer processor coupled to the memory and the interface and programmed to perform the steps of:
obtaining, via the interface, one or more data requirements;
receiving data from one or more data sources based on the one or more data requirements, the data relating to a plurality of target predictors relating to CPU, input-output, memory, network and application logs;
segregating the data into multiple components comprising a residual component and a rhythm component, the residual component representing variance data and the rhythm component representing static data;
based on the residual component, creating a model to generate prediction data;
combining the rhythm component with the prediction data;
identifying one or more peak points responsive to time-series analysis of the combined rhythm component and prediction data;
categorizing the one or more peak points into known peaks and unknown peaks; and
generating a mitigation response for the unknown peaks.

2. The system of claim 1, wherein the known peaks comprise seasonal batch jobs, weekly batch jobs and high traffic time periods.

3. The system of claim 1, wherein the unknown peaks represent performance data spikes.

4. The system of claim 3, wherein the performance data spikes are a result of one or more: database timeouts, high input output response times and virtual machine out of memory.

5. The system of claim 1, wherein the prediction data is for predetermined time period.

6. The system of claim 1, wherein the prediction data is represented as weekly trends.

7. The system of claim 1, wherein the prediction data is represented as daily trends.

8. The system of claim 1, wherein the rhythm component comprises a seasonal subcomponent and a trend subcomponent.

9. The system of claim 1, wherein the residual component represents noise data.

10. The system of claim 1, wherein the mitigation response comprises one or more of: notifications, health checks and resource allocation.

11. A method that implements performance metrics predictions, the method comprising the steps of:
obtaining, via an interface, one or more data requirements;
receiving data from one or more data sources based on the one or more data requirements, the data relating to a plurality of target predictors relating to CPU, input-output, memory, network and application logs;
segregating the data into multiple components comprising a residual component and a rhythm component, the residual component representing variance data and the rhythm component representing static data;
based on the residual component, creating a model to generate prediction data;
combining the rhythm component with the prediction data;
identifying one or more peak points responsive to time-series analysis of the combined rhythm component and prediction data;
categorizing the one or more peak points into known peaks and unknown peaks; and
generating a mitigation response for the unknown peaks.

12. The method of claim 11, wherein the known peaks comprise seasonal batch jobs, weekly batch jobs and high traffic time periods.

13. The method of claim 11, wherein the unknown peaks represent performance data spikes.

14. The method of claim 13, wherein the performance data spikes are a result of one or more: database timeouts, high input output response times and virtual machine out of memory.

15. The method of claim 11, wherein the prediction data is for predetermined time period.

16. The method of claim 11, wherein the prediction data is represented as weekly trends.

17. The method of claim 11, wherein the prediction data is represented as daily trends.

18. The method of claim 11, wherein the rhythm component comprises a seasonal subcomponent and a trend subcomponent.

19. The method of claim 11, wherein the residual component represents noise data.

20. The method of claim 11, wherein the mitigation response comprises one or more of: notifications, health checks and resource allocation.
